(19) United States
(12) Patent Application Publication
(10) Pub. No.: US 2015/0010862 A1
(43) Pub. Date: Jan. 8, 2015

(54) TWO-COMPONENT DEVELOPER FOR DEVELOPING ELECTROSTATIC LATENT IMAGE AND MANUFACTURING METHOD THEREOF

(71) Applicant: Konica Minolta, Inc., Tokyo (JP)

(72) Inventors: Yoshiyasu MATSUMOTO, Tokyo (JP); Kosuke NAKAMURA, Tokyo (JP); Satoshi UCHINO, Tokyo (JP); Hidehito HARUKI, Tokyo (JP); Hiroyuki KOZURU, Otsuki-shi (JP)

(21) Appl. No.: 14/323,025

(22) Filed: Jul. 3, 2014

(30) Foreign Application Priority Data
Jul. 5, 2013 (JP) 2013-141401

(51) Int. Cl. G03G 9/113; G03G 9/087

(52) U.S. Cl. CPC G03G 9/1133; G03G 9/08755
USPC 430/108.3; 430/109.1; 430/109.4; 430/137.11; 430/137.13

(57) ABSTRACT

According to one implementation, a two-component developer for developing an electrostatic latent image includes a toner particle and a carrier particle. The toner particle includes an external additive on a surface of a toner mother particle including at least a binding resin. The carrier particle includes a resin covering layer on a surface of a carrier core material particle. The resin covering layer includes a covering resin obtained by polymerizing at least an isobutyl methacrylate monomer and includes a nitrogen atom as an atom composing the covering resin.

### BACKGROUND

1. Field of the Invention

The present invention relates to a two-component developer for developing an electrostatic latent image and a manufacturing method thereof. Specifically, the present invention relates to a two-component developer for developing an electrostatic latent image and a manufacturing method thereof in which fogging does not occur even if there is a change in the printing rate of the image.

2. Description of Related Art

Chemical toner with a sphere shaped particle and a small particle diameter synthesized by suspension polymerization method or emulsion aggregation method has been used to enhance image quality. Such chemical toner is manufactured as an aqueous type and easily absorbs moisture, and there is a problem that the charge amount greatly depends on the environment compared to grinded toner.

In order to cope with this problem, in the developer, resin (covering resin) used for a resin covering layer of a carrier particle is hydrophobized to reduce difference of charge amount depending on the environment.

Conventionally, covering resin using silicone resin has been proposed as hydrophobized resin.

However, since the film of silicone resin is hard and difficult to scrape, when the toner spents (A state where crushed material of toner, external additive of toner, or a component of a toner mother particle is attached to a carrier surface is called spent. Hereinafter spent of toner is referred to as “toner spent”.), the surface of the carrier particle is not refreshed by wearing of the film. Therefore, when a large number of sheets are printed, the charge amount drastically decreases, and this causes problems such as the density of the printed image becoming unstable at the end of the durable period.

In order to prevent such toner spent, there is proposed a cyclohexyl methacrylate which is polymerized with a non-aqueous type in which attaching strength to the toner particle is weak and a contact angle is high so that the film can be scraped to a suitable degree (for example, see Japanese Patent No. 3691085).

A two-component developer is disclosed where a resin in which an acrylic monomer including nitrogen (acrylic monomer including amino group or a derivative thereof) is copolymerized with a monomer including cycloalkyl group is used for the resin covering layer of the carrier particle, and the nitrogen atom is introduced in the resin covering layer to enhance charge applying ability of the carrier particle (for example, see Japanese Patent Application Laid-Open Publication No. 2009-300531).

Lately, there is a demand from customers of production printing devices to be able to handle a wider range of a printing rate. This means there is a demand to obtain the same image (as the developer characteristic, the charge amount is the same) even when there is a change in the printing rate, in other words, a change in the speed that the toner is supplied.

When the speed of supplying the toner changes, although the supplying speed of the contaminant to the carrier changes, the refreshing speed (film wearing speed) of the surface of the carrier particle is a certain speed in proportion with the churning time of the developing device, and the relative speeds of the above changes. In other words, when the printing rate increases, the film wearing speed is not sufficient compared to the supplying speed of the contaminant. Therefore, the deterioration of the carrier particle occurs and the charge amount reduces. As a result, there is a problem that fogging occurs.

In order to prevent the toner spent on the surface of the carrier particle, a resin using isobutyl methacrylate monomer polymerized with a non-aqueous type with a large contact angle against water is proposed (for example, see Japanese Patent Application Laid-Open Publication No. H7-219280).

However, as described above, since the chemical toner highly depends on the environment, when carrier particles covered with resin obtained by polymerizing isobutyl methacrylate monomer is used, there is a problem that the charge amount of the toner largely changes according to the change of the temperature and humidity of the environment.

### SUMMARY

The present invention has been made in consideration of the above problems, and it is one of main objects to provide a two-component developer for developing an electrostatic latent image and manufacturing method thereof in which image density is stable even when a large number of sheets are printed, change of charge amount is small even when environment of printing changes, and fogging does not occur even if the printing rate of the image changes.

In order to solve the above problems, while considering the reasons of the above problems, the inventors of the present invention used various methods such as synthesizing resin using nitrogen included compounds as the polymerization initiator of the resin, and introducing nitrogen included resin fine particles or the like to raise the charge amount level. With this, the inventors found that the desired charge capabilities can be achieved throughout the entire durable period.

As a result, the inventors found that it is possible to obtain a two-component developer for developing an electrostatic latent image (hereinafter also referred to as “two-component developer”) with no fogging and a stable image density even at the end of the durable period or when the printing rate changes, and achieved the present invention.

The inventors found that by changing the ratio of the nitrogen atom included in the upper layer (surface side) and the lower layer (carrier core material particle side) in the resin covering layer of the carrier particle, it is possible to obtain stability of the image density even at the end of the durable period or when the printing rate changes, and with this it is possible to obtain a two-component developer where the above effects are enhanced.

In order to achieve at least one of the above-described objects, according to an aspect of the present invention, there is provided a two-component developer for developing an electrostatic latent image including:

a toner particle including an external additive on a surface of a toner mother particle including at least a binding resin; and

a carrier particle including a resin covering layer on a surface of a carrier core material particle,

wherein the resin covering layer includes a covering resin obtained by polymerizing at least an isobutyl methacrylate monomer and includes a nitrogen atom as an atom composing the covering resin.

Preferably, in the two-component developer for developing an electrostatic latent image, when the resin covering layer is divided between a carrier core material particle side and a surface side, weight of a nitrogen atom included in the carrier core material particle side is 1.05 times or more of weight of a nitrogen atom included in the surface side.

Preferably, in the two-component developer for developing an electrostatic latent image, wherein the binding resin includes at least polyester resin.

Preferably, in the two-component developer for developing an electrostatic latent image, weight average molecular weight of the covering resin is within a range of 300,000 to 900,000.

Preferably, in the two-component developer for developing an electrostatic latent image, the external additive includes a silica particle with an average particle diameter within a range of 70 to 130 nm.

Preferably, in the two-component developer for developing an electrostatic latent image, the resin covering layer includes covering resin obtained by copolymerizing at least the isobutyl methacrylate monomer and a methyl methacrylate monomer.

### BRIEF DESCRIPTION OF THE DRAWINGS

The present invention will become more fully understood from the detailed description given hereinbelow and the appended drawings, and thus are not intended to define the limits of the present invention, and wherein;

FIG. 1 is a diagram schematically showing a cross-section of a carrier particle showing a method of measuring nitrogen atomic weight included in a resin covering layer; and

FIG. 2 is a diagram schematically showing an apparatus for measuring charge amount of a two-component developer.

### DETAILED DESCRIPTION OF PREFERRED EMBODIMENTS

The two-component developer for developing an electrostatic latent image according to the present invention includes a toner particle including an external additive on a surface of a toner mother particle including at least a binding resin and a carrier particle including a resin covering layer on a surface of a carrier core material particle, wherein the resin covering layer includes a covering resin obtained by polymerizing at least an isobutyl methacrylate monomer, and a nitrogen atom is included as an atom composing the covering resin. With this, the present invention achieves the outstanding effect of stable image density even after printing a large number of sheets, small change in charge amount even if the environment of printing changes (for example, change from room temperature and normal humidity to high temperature and high humidity), no fogging even if there is a change in the printing rate of the image (for example, printing rate from 3% to 35%), and continuously obtaining high quality printed matter.

The mechanism of obtaining the effects of the present invention is not clear, however, it is predicted to be the following.

In order to achieve mechanical characteristics such as anti-wearing properties of the covering resin of the carrier particle and to prevent the charge amount reducing due to the water absorption under high temperature and high humidity, isobutyl methacrylate with high hydrophobic character is used as the chain methacrylate ester in the covering resin. Although isobutyl methacrylate has the effect of reducing the charge amount, depending on the toner type (especially toner including polyester as a part of the resin), the charge amount level becomes low. This causes fogging and applying this monomer alone becomes difficult.

Therefore, the inventors raised the charge amount level by using methods such as synthesizing resin using nitrogen included compounds as the polymerization initiator of the resin, introducing nitrogen included resin fine particles, or the like. Further, in order to apply stability even during the durable period and when the printing rate changes, the ratio of the nitrogen atom included in the upper layer and the lower layer of the resin covering layer of the carrier particle is changed. With this, it is confirmed that according to the present invention, the desired charge capabilities can be achieved throughout the entire durable period and a two-component developer without fogging and stable image density can be achieved even at the end of the durable period or even when the printing rate changes.

Below, the mechanism of obtaining the above effects is described in detail.

When the two-component developer is churned in the developing device for a long period of time, the toner particle and the external additive is attached to the surface of the carrier particle (spent), and the charge applying capabilities of the carrier particle decreases. Therefore, the charge amount of the toner particle decreases.

Conventionally, the resin covering layer provided on the surface of the carrier particle is polished and worn a small amount at a time by mechanical stress such as churning. With this, the toner particle and the external additive refresh the surface of the spent carrier particle, and charge applying capabilities similar to the initial capabilities are held.

However, there is a problem that when the layer thickness of the resin covering layer is worn to a certain layer thickness or less, the charge amount of the toner particle rapidly decreases, and high quality printed material cannot be obtained continuously.

In order to solve this problem of the charge amount rapidly decreasing, the inventors found that if the carrier particle in which the density of the nitrogen atom in the resin covering layer is higher in the side closer to the carrier core material particle is used, the charge applying capabilities can be maintained at a same level as the initial capabilities even if the layer thickness of the resin covering layer is worn.

The carrier particle used in the present invention includes a layer in which density of the nitrogen atom increases as the wearing of the resin covering layer progresses in the latter half of the durable period. The contribution of the nitrogen atom in the resin covering layer makes up for the decrease of the charge applying capabilities due to the wearing of the layer thickness of the resin covering layer. Therefore, the positive charge applying capabilities of the carrier particle is maintained. It is presumed that as a result of the above, the decrease of the charge amount of the toner particle does not occur, and the stable charge amount can be secured even if a large number of sheets is printed.

If the nitrogen atom weight in the resin covering layer is large throughout the entire layer, there is a possibility that the charge amount of the toner particle becomes too high at the initial period of printing. Therefore, in order to obtain printing with preferable image density, it is preferable that the ratio of the nitrogen atom included inclines toward one side.

Charging of the toner particle is induced by contact charging. Therefore, there is a characteristic that essentially, this easily receives influence of the environment. Specifically, the capability easily becomes unstable due to the influence of temperature and humidity. The cyclohexyl methacrylate (CHMA) resin used in the prior art has a large water content and there is a problem that if this resin is used, the charge amount largely differs depending on the environment. Therefore, there is a proposal to employ methods such as balancing with the water content of the toner particle in order to reduce the difference of charge amount depending on the environment.

According to the present invention, isobutyl methacrylate is used as a portion of the copolymerized monomer in the covering resin. The inventors found that with this, the water content of the carrier particle decreases, and the difference of the charge amount depending on the environment decreases.

Here, the printing rate is the percentage of the printed area (area printed with toner) with respect to the area of the entire image. For example, when a black rectangular image with a size of 105×147.5 mm is printed on a paper of A4 (210×297 mm), the printing rate is 25%.

From the view point of the effect of the present invention, according to the embodiment of the present invention, it is preferable that when the resin covering layer is divided between the carrier core material particle side and the surface side, the weight of the nitrogen atom included in the carrier core material particle side is 1.05 times the weight of the nitrogen atom included in the surface side. This is preferable because it is possible to achieve the following effects, the image density becomes stable even if a large number of sheets is printed, change of the charge amount is small even if the environment of printing changes, and fogging does not occur even if there is a change in the printing rate of the image (for example printing rate 3% to 35%), and high quality printed matter can be continuously obtained.

Preferably, in the present invention, the binding resin includes at least polyester resin. With this, it is possible to achieve the effect of suppressing the change of the charge amount.

Preferably, in the present invention, the weight average molecular weight of the covering resin is within the range of 300,000 to 900,000. With this, since the intensity of the resin becomes high to a certain extent, it is possible to obtain the effect of refreshing the surface of the carrier particle with suitable film wearing.

Preferably, in the present invention, the external additive includes silica particles with an average diameter within the range of 70 to 130 nm. The silica particle with the average particle diameter of 70 nm or more is not easily immersed in the toner particle during printing. The silica particle with the average particle diameter of 130 nm or less does not easily separate from the surface of the toner particle during printing. With this, according to the present invention including the above silica particle, it is possible to obtain the effect of continuously securing the charge applying capabilities and preventing fogging even if a large number of sheets is printed.

Preferably, in the present invention, the resin covering layer includes resin covering resin obtained by copolymerizing at least isobutyl methacrylate monomer with methyl methacrylate monomer. With this, it is possible to achieve the following effects of the wearing resistance and the electrical resistance becoming stable, the charge amount of the developer becoming stable, and the image density becoming stable.

Preferably, in the present invention, there is a manufacturing method of a two-component developer for developing an electrostatic latent image including a toner particle with an external additive attached on a surface of a toner mother particle including at least a binding resin; and a carrier particle with a resin covering layer formed on a surface of a carrier core material particle, the method includes the following, forming the resin covering layer including a nitrogen atom as an atom composing a covering resin in the covering resin obtained by polymerizing at least isobutyl methacrylate monomer. With this, it is possible to achieve the following effects, the image density becomes stable even if a large number of sheets is printed, change of the charge amount is small even if the environment of printing changes, fogging does not occur even if there is a change in the printing rate of the image (for example, printing rate 3% to 35%), and printed matter with high quality can be continuously obtained.

Preferably, in the present invention, the manufacturing method of a two-component developer for developing an electrostatic latent image includes forming the resin covering layer so that weight of the nitrogen atom included in the resin covering layer increases stepwise or successively from a surface side to a carrier core material particle side of the resin covering layer. With this, it is possible to achieve the following effects, the image density becomes stable even if a large number of sheets is printed, change of the charge amount is small even if the environment of printing changes, fogging does not occur even if there is a change in the printing rate of the image (for example, printing rate 3% to 35%), and printed matter with high quality can be continuously obtained.

The present invention and its elements, and embodiments of the present invention are described in detail below. When a range of values is shown, the minimum value and the maximum value are included.

### (Outline of Two-Component Developer for Developing Electrostatic Latent Image of the Present Invention)

According to the present invention, a two-component developer for developing an electrostatic latent image includes, a toner particle including an external additive on a surface of a toner mother particle including at least a binding resin, and a carrier particle including a resin covering layer on a surface of a carrier core material particle, wherein the resin covering layer includes a covering resin obtained by polymerizing at least an isobutyl methacrylate monomer and includes a nitrogen atom as an atom composing the covering resin.

According to the present invention, the nitrogen atom included in the covering resin means, the nitrogen atom is included as an atom composing the covering resin.

The two-component developer of the present invention is described in detail below.

### <<Two-Component Developer>>

The two-component developer of the present invention includes a toner particle in which an external additive is attached to a toner mother particle and a carrier particle in which a resin covering layer is provided on a surface of a carrier core material particle.

The two-component developer of the present invention can be obtained by mixing the carrier and the toner using a mixer apparatus.

For example, there are mixer apparatuses such as Henschel mixer (product of Mitusi Miike Chemical Engineering Machinery Co., Ltd.), nauta mixer (product of Powdertech Co., Ltd.), or V-type mixer.

A compounding ratio between the carrier and the toner is preferably, 3 to 15 parts by mass of toner with respect to 100 parts by mass of carrier, and more preferably, 4 to 10 parts by mass of toner.

Next, members used in the present invention are described.

### <<Carrier Particle>>

The carrier particle used in the present invention is provided with a resin covering layer on a surface of a carrier core material particle. According to the present invention, the resin covering layer includes a covering resin obtained by polymerizing at least an isobutyl methacrylate monomer and the nitrogen atom included as an atom composing the covering layer.

When the resin covering layer is divided between the carrier core material particle side and the surface side, it is preferable that the nitrogen atomic weight included in the carrier core material particle side is larger than the nitrogen atomic weight included in the surface side. With this, the image density becomes stable even if a large number of sheets is printed, change of the charge amount is small even if the environment of printing changes, fogging does not occur even if there is a change in the printing rate of the image (for example, printing rate 3% to 35%), and printed matter with high quality can be continuously obtained.

### <Carrier Core Material Particle>

As the carrier core material particle, iron powder, magnetite, various ferritic particles or any of the above dispersed in the resin can be used. Preferably, the carrier core material particle is magnetite or various ferritic particles. It is preferable to use ferrite including heavy metal such as copper, zinc, nickel, manganese, etc. or light metal ferrite including alkali metal or alkali earth metal.

Specifically, according to the present invention, the ferrite used in the carrier core material particle is a chemical compound represented by the formula: (MO)×(Fe₂O₃)y, and it is preferable to set a mole ratio y of the Fe₂O₃ of the ferrite as 30 mole % to 95 mole %. Preferable magnetizing can be easily obtained with the ferrite particle in which the composition ratio y is within the above range, and there is a merit of making a carrier so that carrier adhesion hardly occurs. M in the formula is a metal atom such as manganese (M), magnesium (Mg), strontium (Sr), calcium (Ca), titanium (Ti), copper (Cu), zinc (Zn), nickel (Ni), aluminum (Al), silicon (Si), zirconia (Zr), bismuth (Bi), cobalt (Co), lithium (Li), and the above can be used alone or by combining a plurality of types. M of the above with iron atom Fe is ferrous ferrite, in other words, magnetite, and since the residual magnetization is high, this is not preferable.

It is preferable that the volume average particle diameter of the carrier core material particle is within the range of 10 to 100 μm, and more preferably within the range of 20 to 80 μm. The carrier core particle with the particle diameter within this range is suitable for obtaining printed matter with a high resolution.

Further, it is preferable that the magnetization attribute included in the carrier core material particle itself is within the range of 2.5×10⁻⁵ to 15.0×10⁵ Am²/kg (WB·m/kg) at saturated magnetization.

The volume average particle diameter of the carrier core material particle is the average particle diameter of a volumetric basis measured by “HELOS” (product of Sympatec) which is a laser diffraction type particle diameter distribution measuring apparatus including a wet-type dispersion device.

Saturated magnetization is a value measured with “direct current magnetization attribute automatic recording device 3257-35” (product of Yokogawa Electric Corporation).

### (Resin Covering Layer)

According to the carrier particle of the present invention, the resin covering layer includes covering resin obtained by polymerizing at least the isobutyl methacrylate monomer and includes the nitrogen atom as the atom included in the covering resin.

Specifically, according to the present invention, it is preferable that the weight average molecular weight of the covering resin is within the range of 300,000 to 900,000. With this, since the strength of the resin becomes high to a certain degree, it is possible to obtain the effect that the surface of the carrier particle is refreshed by suitable film wearing.

From the viewpoint of durability of the carrier particle and the low electrical resistance, it is preferable that the average layer thickness of the resin covering layer is within the range of 0.05 to 4.0 μm, and more preferable within the range of 0.2 to 3.0 μm.

As the covering resin used to form the resin covering layer of the carrier particle, other than the covering resin obtained by polymerizing at least the isobutyl methacrylate monomer, a well-known acrylic resin can be included.

For example, as the well-known acrylic resin, other than the homopolymer of isobutyl methacrylate, there is copolymer with the following, chain methacrylate ester monomer such as methyl methacrylate, ethyl methacrylate, propyl methacrylate, n-butyl methacrylate, hexyl methacrylate, octyl methacrylate, and 2-ethylhexyl methacrylate; alicyclic estel methacrylate monomer such as cyclopropyl methacrylate, cyclobutyl methacrylate, cyclopenthyl methacrylate, cyclohexyl methacrylate, cycloheptyl methacrylate including cycloalkyl ring within the range of carbon atoms 3 to 7, and styrene monomer such as styrene, α-methylstyrene, and p-choloro styrene. Among the acrylic resin, from the view point of wearing resistance and electrical resistance, it is preferable to use a copolymer with chain methacrylate ester monomer, and it is especially preferable to use methyl methacrylate.

Such resin can be used as one type alone, or as a copolymer combining two or more types of monomers. For example, when a copolymer of isobutyl methyl methacrylate and methyl methacrylate is used, the surface of the carrier particle is easily refreshed and its durability against stress in the developer is excellent, and is therefore preferable. Specifically, it is preferable that the resin is obtained by polymerizing including isobutyl methacrylate monomer in the resin 20 percent by mass or more. When the isobutyl methacrylate monomer is within the above range, excellent hydrophobic character can be obtained, and the change of charge capabilities due to change of temperature and humidity environment can be made small.

The covering resin can be a resin where two or more types of covering resin are added and mixed. The method of mixing is not limited as long as the covering resin including both colorants are made separately, and then the covering resin are mixed.

It is preferable that the mixing of the two types of covering resin is performed without applying stress to the covering resin and a well-known mixer can be used. Specifically, for example, the following mixers can be used, a V-type mixer, a Nauta mixer, a Henshcel mixer, and the like.

### [Method of Determining Amount of Two Types of Covering Resin]

The amount of mixing the two types of covering resin can be managed by the amount input in preparation. The actual accurate contained amount can be measured by elementary analysis by wavelength dispersive X-ray spectroscopy method (WDX) using the completed covering resin as the example.

In other words, the X-ray fluorescence spectroscopy “XRF-1700” (product of Shimadzu Corporation) can be used to measure the weight of atoms. Specifically, pressure is applied to 2 g of the sample and made into a pellet, and this is measured by quantitive analysis under the following conditions.

A Kα peak angle of an atom to be measured is determined from a 2θ table and used in the measurement.
X-ray generating unit condition/target: Rh, tube voltage: 40 kV, tube current: 95 mA, filter: none
spectroscopic system condition/slit: normal, attenuator: none, dispersive crystal (S═Ge, C═LiF), detector (S=FPC, C=FPC)

According to the present invention, it is preferable that the resin covering layer includes the covering resin obtained by copolymerizing at least the isobutyl methacrylate monomer and the methyl methacrylate monomer. With this, the wearing durability and the electrical resistance becomes stable, the charging amount of the developer becomes stable, and consequently, the effect of the image density becoming stable can be obtained.

### (Nitrogen Atom)

The carrier particle used in the present invention includes a nitrogen atom in the resin covering layer.

According to the present invention, when the resin covering layer is divided between the carrier core material particle side and the surface side, it is preferable that the weight of the nitrogen atom included in the carrier core material particle side is 1.05 times or more with respect to the weight of the nitrogen atom included in the surface side, and more preferably within the range of 1.10 times to 2.00 times.

### (Measurement of Weight of Nitrogen Atom Included in Resin Covering Layer)

The weight of the nitrogen atom included in the resin covering layer can be measured by the following.

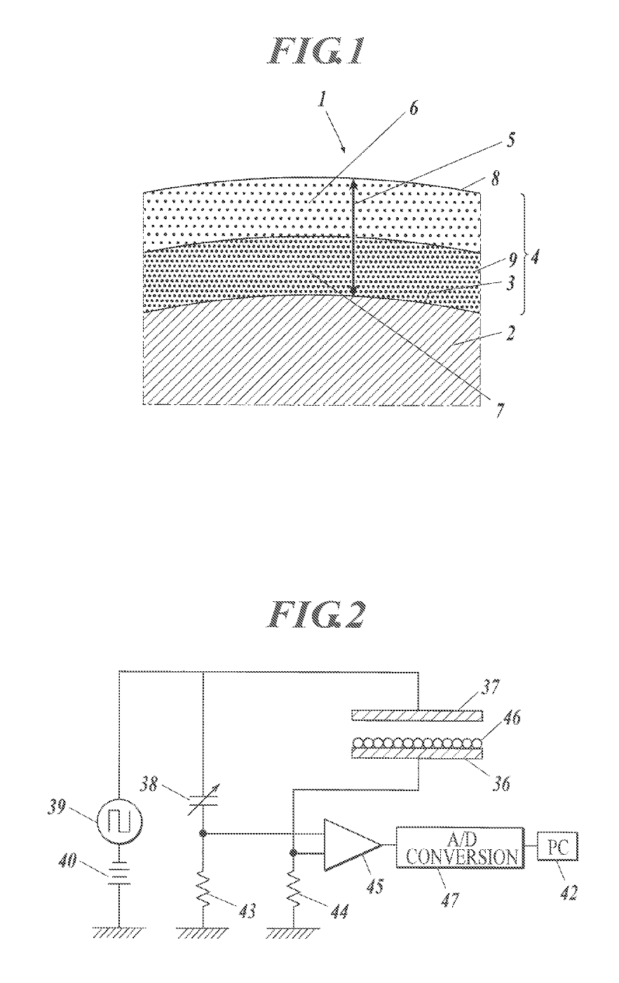

FIG. 1 is a diagram schematically showing a cross section of the carrier particle showing the measurement method of the nitrogen atomic weight included in the resin covering layer.

In FIG. 1, reference number 1 shows a cross section of the carrier particle, reference number 2 shows the carrier core material particle, reference number 3 shows the surface of the carrier core material particle, reference number 4 shows the resin covering layer, reference number 5 shows the thickness of the layer of the resin covering layer, reference number 6 shows the resin covering layer of the surface side, reference number 7 shows the resin covering layer of the carrier core material particle side, reference number 8 shows the surface of the resin covering layer, and reference number 9 shows the nitrogen atom.

A cross section sample of the carrier particle is formed with the cross section polisher method (CP method), and an image magnified 300,000 times is captured with a scanning electron microscope (SEM). As shown in FIG. 1, in the captured image (SEM image), the resin covering layer thickness 5 is divided into two pieces in the thickness direction so as to divide the average layer thickness of the resin covering layer thickness 5 in half, and the portion closer to the carrier core material particle is to be “carrier core material particle side resin covering layer 7”, and the other portion is to be “surface side resin covering layer 6”. Next, element mapping is performed with energy dispersive X-ray spectrometry (EDS) in the same field of view. Here, peak separation is suitably performed to divide the nitrogen atom 9 and other atoms by color. The image processing apparatus (for example, LUZEX) is used to overlap the obtained mapping image with the SEM image, and the area occupied by the nitrogen atom 9 is calculated for each of the carrier core material particle side resin covering layer 7 and the surface side resin covering layer 6. This is divided by the total area of the cross section of each of the carrier core material particle side resin covering layer 7 or the surface side resin covering layer 6, and the weight of the nitrogen atom for each unit area is calculated for each of the carrier core material particle side resin covering layer 7 and the surface side resin covering layer 6. Such measurement is performed in three fields of view, the average value of the three fields of view is obtained for each of the carrier core material particle side and the surface side, and this is to be the “carrier core material particle side nitrogen atomic weight” and the “surface side nitrogen atomic weight”. The atomic weight can be determined by intensity of the mapping of the nitrogen atom.

It is preferable that the carrier particle used in the present invention has an electric resistance value within the range of 10⁷ to 10¹² Ωcm, and more preferably within the range of 10⁸ to 10¹¹ Ωcm. By making the electric resistance value of the carrier particle within the above range, the carrier particle becomes most suitable for forming a toner image with high density.

It is preferable that the carrier particle used in the present invention has saturated magnetization within the range of 30 to 80 Am²/kg, and remanent magnetization of 5.0 Am²/kg or less. By using the carrier particle with such magnetic property, it is possible to prevent the carrier particles from partially aggregating, to evenly disperse the two-component developer on the surface of the two-component developer conveying member, and to develop so as to form a toner image which is fine and smooth without unevenness in density.

The remanent magnetization can be made smaller by using ferrite. When the remanent magnetization is small, the fluidity of the carrier itself is enhanced, and the two-component developer with even bulk density can be obtained.

### (Manufacturing Method of Two-Component Developer for Developing Electrostatic Latent Image)

Various conventionally well-known methods can be used as the method for manufacturing the electrostatic latent image developing two-component developer of the present invention.

According to the present embodiment, it is preferable that the manufacturing method of the electrostatic latent image developing two-component developer including the toner particle with the external additive attached to the surface of the toner mother particle including at least the binding resin and the carrier particle with the resin covering layer formed on the surface of the carrier core material particle is a method including a step to form the resin covering layer including the nitrogen atom as the atom composing the covering resin on the covering resin obtained by polymerizing at least isobutyl methacrylate monomer. With this, the following effects can be achieved, the image density becoming stable even if a large number of sheets is printed, change of the charge amount being small even if the environment of printing changes, no fogging even if there is a change in the printing rate of the image (for example, printing rate 3% to 35%), and continuously obtaining high quality printed matter.

### (Resin Covering Layer Forming Step)

In the step to form the resin covering layer, the nitrogen atom is included as the atom composing the covering resin in the covering resin obtained by polymerizing at least the isobutyl methacrylate monomer, and the resin covering layer is formed.

In the present invention, it is preferable that the step forms the resin covering layer increasing the weight of the nitrogen atom included in the resin covering layer stepwise or successively from the surface side to the carrier core material particle side of the resin covering layer. With this, the following effects can be obtained, the image density becoming stable even if a large number of sheets is printed, change of the charge amount being small even if the environment of printing changes, no fogging even if there is a change in the printing rate of the image (for example, printing rate 3% to 35%), and continuously obtaining high quality printed matter.

### <<Making Carrier Particle>>

The carrier particle is made by providing the resin covering layer on the surface of the carrier core material particle.

There are a wet-type coating method and a dry-type coating method as the methods of providing the resin covering layer on the surface of the carrier core material particle in the step of forming the resin covering layer, and the resin covering layer can be provided by either method. Each method is described below.

### (Wet-Type Coating Method)

### (1) Fluid Bed Type Spray Coating Method

According to the fluid bed type spray coating method (also referred to as solvent coating method), a coating liquid in which the covering resin is dissolved in a solvent is applied by spraying on the surface of the carrier core material particle using a fluid spray coating apparatus, and then this is dried to make the resin covering layer.

### (2) Immersion Type Coating Method

According to the immersion type coating method, the carrier core material particle is immersed in the coating liquid in which the covering resin is dissolved in the solvent to perform coating processing, and then this is dried to make the resin covering layer.

### (3) Polymerizing Method

According to the polymerizing method, the carrier core material particle is immersed in the coating liquid in which a reactive compound is dissolved in the solvent to perform coating processing, and heat is applied to cause a polymerizing reaction to make the resin covering layer.

### (Dry-Type Coating Method)

The dry-type coating method is a method which adds mechanical impact or heat to coat the surface of the carrier material particle with the coating resin (also referred to as mechanochemical method), and the resin covering layer is formed by the following steps 1 to 3.

step 1: A coating material in which covering resin particles which are to be covered and solids added as necessary (for example, resin particles) are dispersed is mechanically churned with the carrier coating material particle, and the coating material is attached to the surface of the carrier core material particle.

step 2: Then, the covering resin particle in the coating material attached to the surface of the carrier core material particle by applying mechanical impact or heat is melted or softened to be fixed, and the resin covering layer is formed.

step 3: The above steps 1 to 2 are repeated as necessary to form the resin covering layer with the desired thickness.

As an apparatus using the method of coating by applying mechanical impact or heat, there is a grinder including a rotor and a liner or a high speed churning mixer with churning blades such as “Turbo mill” (product of Turbo Corporation), pin mill, “Kryptron” (product of Kawasaki Heavy Industries, Ltd.). Among the above, the high speed churning mixer with churning blades is preferable because the resin covering layer can be made favorably.

In heating, it is preferable that the heating temperature is within the range of 60 to 125° C. When heating is at a temperature within the above range, aggregation among the resin covered carrier particles do not occur, and the covering resin can be fixed on the surface of the carrier core material particle.

According to the present invention, the resin covering layer can be formed by the wet-type coating method, the dry-type coating method, or the coating method combining the wet-type coating method and the dry-type coating method. Among the above, it is preferable to use the dry-type coating method because an even resin covering layer can be easily formed.

### (Introducing Nitrogen Atom in Resin Covering Layer)

The following three methods are methods for introducing the nitrogen atom in the resin covering layer.

### (1) Method Using Resin Obtained by Polymerizing Monomer Including Nitrogen Atom

The resin obtained by polymerizing monomer including the nitrogen atom can be obtained by copolymerizing alicyclic methacrylate ester with the monomer including the nitrogen atom.

As the monomer including the nitrogen atom, there are acrylic monomer including amino group such as dimethylamide acrylate, dimethylamide methacrylate, dimethylaminoethyl methacrylate, diethylaminoethyl methacrylate, dimethylaminobutyl methacrylate, methylaminoethyl methacrylate, etc., acrylic monomer including nitrogen with derivatives, etc. of the above, or monomer introducing nitrogen groups such as vinylpirrolidone, etc.

There are also monomer composed of amino resin such as polyurethane resin, phenol resin, urea-formaldehyde resin (urea resin), melamine resin, benzoguanamine resin, polyamide resin, etc., monomer composed of epoxy resin, etc., or the like.

Among the above, acrylic monomer including nitrogen is preferable because the carrier can easily hold charge applying capabilities. Among these, acrylic monomer including the amino group is more preferable, and dimethylaminoethyl methacrylate is more preferable. The added amount of monomer including nitrogen atom is preferably within the range of 0.1 to 20 parts by mass with respect to the entire resin covering layer, and more preferably within the range of 0.2 to 10 parts by mass.

### (2) Method Using Polymerization Initiator Including Nitrogen Atom (Nitrogen Atom Included Initiator) in the Polymerization Initiator Used in Synthesizing Resin

When the resin is synthesized, an initiator including the nitrogen atom can be used to position and introduce the nitrogen atom in an end of the molecular chain (in the resin structure).

A decomposed product remaining from decomposition of the initiator including the nitrogen atom remain as the end group of the polymer chain. The degree of polarization of the end group dominates polarity and charge applying capabilities of the carrier itself.

As initiators including the nitrogen atom there are, 2,2′-bis(2-imidazoline-2-yl)[2,2′-azobispropane]•dihydrochrolide, 2,2′-bis(2-imidazoline-2-yl)[2,2′-azobispropane]•disulfate dehydrate, 2,2′-azobis-2-amidinopropane dihydrochloride, 2,2′-azobis[N-(2-carboxyethyl)-2-methylpropionamidine], 2,2′-azobis{2-[1-(2-hydroxyehtyl)-2-imidazoline-2-yl]propane}•dihydrochloride, 2,2′-azobis[2-(2-imidazoline-2-yl)propane], 2,2′-azobis(1-imino-1-pyrrolidino-2-methylpropane)•dihydrochloride, 2,2′-azobis(2-methyl-N-[1,1-bis(hydroxymethyl)-2-hydroxyethyl]propionamide), 2,2′-azobis-[N-(2-hydroxyethyl)-2-methylpropaneamide], 2,2′-azobis-(4-methoxy-2,4-dimethylvaleronitrile), 2,2′-azobis(2,4-dimethylvaleronitrile), 2,2′-azobis(2-methylbutylonitrile), 1,1′-azobis(cyclohexane-1-carbonitrile), 2,2′-azobis(2-methyl-n-2-propenylpropaneamide), 1,2-didehydro-1-(1-cyano-1-methylethyl)semicarbazide, 2,2′-azobis(n-butyl-2-methylpropioneamide), 2,2′-azomis(n-cyclohexyl-2-methylpropioneamide).

Among the above, the following are preferable from the viewpoint of polarity strength and easier control of polymerization reaction, 2,2′-azobis-2-amidinopropane dihydrochloride, 2,2′-azobis(1-imino-1-pyrrolidino-2-methylpropane)•dihydrochloride, 2,2′-azobis-(4-methoxy-2,4-dimethylvaleronitrile), 2,2′-azobis(2,4-dimethylvaleronitrile), and 2,2′-azobis(2-methylbutylonitrile). The added amount in polymerization reaction is preferably within the range of 0.1 to 10 parts by mass with respect to 100 parts by mass of monomer.

### (3) Method of Adding Resin Particle Including Nitrogen Atom in Resin Covering Layer

It is possible to add and introduce the resin particle including the nitrogen atom in the resin which forms the resin covering layer.

As the resin particle including the nitrogen atom, there are, melamine-formaldehyde resin particle, polyamide resin particle, melamine-benzoguanamine resin particle, etc. Regarding the particle diameter of the resin particle including the nitrogen atom, it is preferable that the number average primary particle diameter is within the range of 50 to 2000 nm. When the number average primary particle diameter is 50 nm or less, there is a possibility that the dispersion of the resin particle in the resin covering layer becomes worse. When the number average primary particle diameter is 2000 nm or more, the resin particle easily falls from the resin covering layer, and therefore the original capabilities may not be exhibited. It is preferable that the contained amount of resin particle including the nitrogen atom is within the range of 1 to 20% by mass of the resin covering layer.

Among the above, methods (1) and (2) are preferable because the evenness of the nitrogen atoms dispersed on the surface of the resin covering layer in wearing is more enhanced, and the charge amount of toner becomes stable.

### (Method of Unevenly Distributing Contained Weight of Nitrogen Atom in Carrier Core Material Particle Side and Surface Side of Resin Covering Layer)

As a method to unevenly distribute the contained weight of the nitrogen atom on the carrier core material particle side and on the surface side in the resin covering layer, there is a method to change the weight of nitrogen atom stepwise or successively to form the resin covering layer.

The resin covering layer including many layers in which the weight of the nitrogen atom is changed stepwise can be made by forming a plurality of resin covering layers in which the type and amount of resin including the nitrogen atom is changed.

As the method of forming the resin covering layer in which the weight of the nitrogen atom is changed successively, the resin including the nitrogen atom and resin not including the nitrogen atom are prepared. After the carrier core material particles are put in, input amount of the resin including the nitrogen atom is increased, and the input amount of the resin not including the nitrogen atom is decreased. Then, the input amount of the resin not including the nitrogen atom is increased, and the input amount of the resin including the nitrogen atom is decreased. With this, it is possible to form the resin covering layer with a large weight of nitrogen atom on the carrier core material particle side and a small weight of nitrogen atom on the surface side.

### (Toner Particle)

The toner particle used here is obtained by attaching an external additive on the surface of the toner mother particle including at least the binding resin.

The toner particle obtained by attaching the external additive to the toner mother particle is preferable because the fluidity of the two-component developer is enhanced. This is preferable because the fluidity of the two-component developer is enhanced and the speed that the toner is charged becomes faster.

### <Making Toner Particles>

The toner particle can be made by attaching the external additive to the toner mother particle. As the method of making the toner particle of the present invention, there are a kneading grinding method, a suspending polymerizing method, an emulsion aggregating method, a dissolving suspending method, a polyester extending method, a dispersion polymerizing method, and the like. Among the above, it is preferable to use the emulsion aggregating method from the viewpoint of even particle diameter, control of shape, and easy forming of core shell structure which are advantageous for high image quality and high stability.

### (Toner Mother Particle)

The toner mother particle of the present invention specifically includes at least binding resin and includes colorant as necessary. The toner mother particle can further include other components such as a parting agent, a charge control agent and the like as necessary. Methods to manufacture such toner mother particles are not limited, and there are well-known methods such as a grinding method, a suspending polymerizing method, a miniemulsion polymerization aggregating method, an emulsion polymerization aggregating method, a dissolving suspending method, a polyester molecule extending method, and the like.

### (Binding Resin)

Preferably, thermoplastic resin is used as the binding resin included in the toner mother particle of the present invention.

The binding resin of the present invention is not limited, and binding resin usually used in toner can be used. Specifically, various well-known resin can be used, for example, vinyl resin such as styrene resin, (meth)acrylic resin, styrene-(meth)acrylic copolymer resin, and olefin resin, polyester resin, polyamide resin, polycarbonate resin, polyether resin, polyvinyl acetate resin, polysulfone resin, epoxy resin, polyurethane resin, urea resin and the like. Further, the above can be used alone or by combining two or more types.

According to the present invention, it is preferable that the binding resin includes at least polyester resin to obtain the effect of suppressing change of charge amount.

### (Colorant)

A colorant can be included in the toner particle composing the toner mother particle as necessary. Well-known inorganic or organic colorant can be used as the colorant. The added amount of the colorant is within the range of 1 to 30% by mass with respect to the entire toner mother particle and preferably within the range of 2 to 20% by mass.

### (Parting Agent)

A parting agent can be included in the toner particle composing the toner mother particle as necessary. Various well-known waxes can be used as the parting agent. Preferably, the added amount of the parting agent in the toner mother particle is within the range of 1 to 30% by mass with respect to the entire toner mother particle and more preferably within the range of 5 to 20% by mass.

### (Charge Control Agent)

A charge control agent can be included in the toner mother particle as necessary. Various well-known compounds can be used as the charge control agent.

### (External Additive)

The two-component developer for developing the electrostatic latent image of the present invention includes an external additive. Although the toner mother particle can be used as the toner particle as is, from the viewpoint of enhancing charge capabilities, fluidity and cleaning capabilities as toner, particles such as well-known inorganic fine particles or organic fine particles or a lubricant can be added to the surface as the external additive (additive processing).

The additive processing is performed by attaching the external additive to the toner mother particle for the purpose of enhancing fluidity of the toner and cleaning capabilities of the toner.

According to the present invention, preferably, the external additive includes a silica particle with the average particle diameter within the range of 70 to 130 nm. With this, it is possible to achieve the following effects, even if a large number of sheets are printed, charge applying capabilities can be continuously secured and fogging can be prevented.

Examples of such silica particles include, for example, R-805, R-976, R-974, R-972, R-812, and R-809 which are commercial products of Nippon Aerosil Co., Ltd., HVK-2150 and H-200 which are commercial products of Hoechst AG, and TS-720, TS-530, TS-610, H-5, MS-5, which are commercial products of Cabot Corporation, and the like.

The types of external additives are not limited, and other than the above, the following inorganic fine particles, organic fine particles, and lubricant can be used.

Conventionally well-known inorganic fine particles can be used, for example, preferably, silica, titania, alumina, and strontium titanate fine particles with the number average primary particle diameter within the range of 10 to 250 nm. The inorganic fine particles of the above processed with hydrophobing processing as necessary can also be used.

The following can be used as titania fine particles, for example, T-805 and T-604 which are commercial products of Nippon Aerosil Co., Ltd., MT-100S, MT-100B, MT-500BS, MT-600, MT-600SS, and JA-1, which are commercial products of Tayca Corporation, TA-300SI, TA-500, TAF-130, TAF-510, and TAF 510T which are commercial products of Fuji Titanium Co., Ltd., IT-S, IT-OA, IT-OB, and IT-OC which are commercial products of Idemitsu Kosan Co., Ltd., and the like.

The following can be used as alumina fine particles, for example, RFY-C, and C-604 which are commercial products of Nippon Aerosil Co., Ltd., TTO-55 which is a commercial product of Ishihara Sangyo Kaisha, Ltd., and the like.

Sphere shaped organic fine particles with the number average primary particle diameter within the range of about 10 to 2000 nm can be used as the organic fine particle. Preferably, there are homopolymer of styrene or methyl methacrylate or copolymer of the above.

The lubricant can be used to further enhance cleaning capabilities and transfer capabilities. For example, the following metallic salt of higher fatty acid can be used. In other words, salt of zinc, aluminum, copper, magnesium, calcium, etc. of stearic acid, salt of zinc, manganese, steel, copper, magnesium, etc. of olein acid, salt of zinc, copper, magnesium, calcium, etc. of palimitic acid, salt of zinc, calcium, etc. of linoleic acid, and salt of zinc, calcium, etc. of ricionelic acid.

Preferably, the added amount of the external additive and the lubricant is within the range of 0.1 to 10.0% by mass with respect to the total toner mass. As the method of adding the external additive and the lubricant, there is a method of using various well-known mixing apparatuses such as TURBULA mixer, Henschel mixer, nauta mixer, V-type mixer, and the like.

Preferably, the method of attaching the external additive to the toner mother particle is a method where the external additive and the toner mother particle is mixed using a mechanical mixer such as a Henschel mixer (product of Mitusi Miike Chemical Engineering Machinery Co., Ltd.).

Preferably, regarding the toner diameter of the toner particle, the volume based median diameter (D₅₀) is within the range of 3.0 to 8.0 μm.

The toner volume based median diameter (D₅₀) is a value measuring and calculating the volume of clear toner within the range of 2.0 to 6.0 μm in aperture diameter 100 μm using the “Coulter Multisizer 3” (product of Beckman Coulter, Inc.).

Next, the image forming method and the image forming apparatus for making printed matter using the two-component developer is described.

### <<Image Forming Method>>

The two-component developer of the present invention can be used in various well-known image forming methods of an electro-photographic type. For example, the developer can be used in a monochrome type image forming method or a full color type image forming method. Any image forming method of the full color type can be used, for example, a four cycle type image forming method including a color developing device of four types of colors consisting of yellow, magenta, cyan, and black, and one electrostatic latent image carrier, or a tandem type image forming method which uses an image forming unit including the color developing device of each color and electrostatic latent image carrier for each color.

### <<Image Forming Apparatus>>

The two-component developer of the present invention can be used in a typical electro-photographic type image forming apparatus including at least the following steps, charging step which applies even charging potential to the image carrier, exposing step which forms the electrostatic latent image on the image carrier with the even charging potential applied, developing step which develops the electrostatic latent image with the toner and images the toner image, transferring step which transfers the toner image on the transfer material, and fixing step which fixes the toner image on the transfer material.

### EXAMPLES

The present invention is specifically described in the following example, however, the present invention is not limited to the examples illustrated below. In the description below, “parts” or “%” show “parts by mass” or “% by mass” respectively unless otherwise noted.

### <<Making Carrier Particles>>

The carrier particle is made as described below.

### <Preparing Carrier Core Material Particle>

A “ferrite particle” of the Mn—Mg type with the volume average size of 60 μm and saturated magnetization of 10.7×10⁻⁵ A /kg (WB·m/kg) is prepared.

### <Making Covering Resin>

### (Making Covering Resin 1)

Monomer of isobutyl methacrylate/methyl methacrylate/dimethylaminoethyl methacrylate is added in sodium benzenesulfonate aqueous solution of 0.3% by mass in a ratio of (95:4.5:0.5) (copolymerization ratio). Ammonium peroxodisulfate is further added in an amount of 0.5% by mass of the total mass of monomer to perform emulsion polymerizing. With this, “covering resin 1” is made. The weight average molecular weight of the obtained covering resin 1 is 500,000.

Table 1 shows the copolymerization ratio of the monomer and the amount of the polymerization initiator used in making the covering resin and the weight average molecular weight of the obtained covering resin. The “covering resins 2 to 7” are made changing the condition as described in table 1.

The weight average molecular weight is a value which is measured by using a well-known measuring apparatus, and according to the present embodiment, the weight average molecular weight of covering resins 1 to 7 are measured with a GPC (Gel Permeation Chromatography).

In other words, the specimen to be measured is dissolved in tetrahydrofuran so that the concentration becomes 1 mg/ml. The dissolving condition is using an ultrasound disperser at room temperature for five minutes. Next, after processing with a membrane filter with a pore size of 0.2 μm, 10 μl of sample dissolving liquid is injected in the GPC. A specific example of the measuring condition of the GPC is described below.

GPC apparatus: HLC-8220 GPC (product of TOSOH CORPORATION)

column: TSKgelG2000HXL (inner diameter 7.8 mm×30 cm) triple (product of TOSOH CORPORATION)

column temperature: 40° C.

solvent: tetrahydrofuran

fluid velocity: 1.0 ml/min

concentration of sample: 0.1% (v/w)

injecting amount of sample: 100 μl

detector: refractive index detector (RI detector)

When measuring the molecular weight of the sample, the calibration curve measuring the molecular weight distribution including the sample by using the singly dispersed polystyrene standard particle is used in calculation. Ten pieces of polystyrene are used for measuring the calibration curve.

TABLE 1

| | RESIN COMPOSITION, | | | | POLYMERIZATION | |
|---|---|---|---|---|---|---|
| | COPOLYMERIZATION | | | | INITIATOR, | WEIGHT AVERAGE |
| | RATIO | | | | % BY MASS | MOLECULAR |
| | *A | *B | *C | *D | *E | WEIGHT |
| COVERING | 95.0 | 4.5 | 0.5 | 0.0 | 0.50 | 500,000 |
| RESIN 1 | | | | | | |
| COVERING | 85.5 | 4.5 | 10.0 | 0.0 | 0.50 | 500,000 |
| RESIN 2 | | | | | | |
| COVERING | 75.5 | 4.5 | 20.0 | 0.0 | 0.50 | 500,000 |
| RESIN 3 | | | | | | |
| COVERING | 95.0 | 4.5 | 0.5 | 0.0 | 1.00 | 280,000 |
| RESIN 4 | | | | | | |
| COVERING | 95.0 | 4.5 | 0.5 | 0.0 | 0.02 | 1,000,000 |
| RESIN 5 | | | | | | |
| COVERING | 90.0 | 5.0 | 0.0 | 0.0 | 0.50 | 500,000 |
| RESIN 6 | | | | | | |
| COVERING | 0.0 | 5.0 | 0.5 | 94.5 | 0.50 | 500,000 |
| RESIN 7 | | | | | | |

*A: ISOBUTYL METHACRYLATE
*B: METHYL METHACRYLATE
*C: DIMETHYLAMINOMETHYL METHACRYLATE
*D: CYCLOHEXYL METHACRYLATE
*E: AMMONIUM PEROXODISULFATE

### (Making Carrier Particle 1)

Under the conditions of inputting 100 parts by mass of “carrier core material particle” and 3.6 parts by mass of “covering resin 2” which are prepared above into the high-speed churning mixer with the churning blade, and the rotating speed of the horizontal rotation blade being 8 m/sec, the above is mixed and churned for 15 minutes at 22° C. Then, the above is mixed for 50 minutes at 120° C. With the operation of the mechanical force (mechanochemical method), a first layer is formed on a surface of the carrier core material particle and a “carrier particle 1” is made. The ratio of the weight of the nitrogen atom between the surface side and the carrier core material particle side (core material particle side) in the resin covering layer of the obtained carrier particle 1 is surface side: core material particle side=1.00:1.00.

### (Measuring Weight of Nitrogen Atom Included in Resin Covering Layer)

A cross section sample of the carrier particle is made with the cross section polisher method (CP method) and capturing of the image is performed at a magnification of 300,000 times with the scanning electron microscope (SEM). In the captured image (SEM image), the resin covering layer thickness is divided in half in the thickness direction so as to divide the average layer thickness of the resin covering layer thickness in half, and the portion closer to the carrier core material particle is to be “carrier core material particle side resin covering layer”, and the other portion is to be “surface side resin covering layer”. Next, element mapping is performed with energy dispersive X-ray spectrometry (EDS) in the same field of view. Here, peak separation is suitably performed to divide the nitrogen atom and other atoms by color. The image processing apparatus (in the present embodiment, LUZEX) is used to overlap the obtained mapping image with the SEM image, and the area occupied by the nitrogen atom is calculated for each of the carrier core material particle side resin covering layer and the surface side resin covering layer. This is divided by the total area of the cross section of each of the carrier core material particle side resin covering layer and the surface side resin covering layer, and the weight of the nitrogen atom for each unit area is calculated for each of the carrier core material particle side resin covering layer and the surface side resin covering layer. Such measurement is performed in three fields of view, the average value of the three fields of view is obtained for each of the carrier core material particle side and the surface side, and this is to be the “carrier core material particle side nitrogen atom weight” and the “surface side nitrogen atom weight”.

### (Making Carrier Particle 2)

### (Forming First Layer)

Under the conditions of inputting 100 parts by mass of “carrier core material particle” and 1.2 parts by mass of “covering resin 2” which are prepared above into the high-speed churning mixer with the churning blade, and the rotating speed of the horizontal rotation blade being 8 m/sec, the above is mixed and churned for 15 minutes at 22° C. Then, the above is mixed for 50 minutes at 120° C. With the operation of the mechanical force (mechanochemical method), a first layer is formed on a surface of the carrier core material particle.

### (Forming Second Layer)

Further, the “covering resin 1” and the “covering resin 2” are each added in the amount of 0.6 parts by mass, and the above is mixed and churned for 15 minutes at 22° C. Then, the above is mixed for 50 minutes at 120° C. With this, a second layer including the “covering resin 1” and the “covering resin 2” is formed on the first layer.

The fixed quantity of the two types of covering resin is measured by using the X-ray fluorescence spectroscopy “XRF-1700” (product of Shimadzu Corporation). Specifically, pressure is applied to 2 g of the sample and made into a pellet, and is measured by quantitive analysis under the following conditions.

A Kα peak angle of an atom to be measured is determined from a 20 table and used in the measurement.
X-ray generating unit condition/target: Rh, tube voltage: 40 kV, tube current: 95 mA, filter: none
spectroscopic system condition/slit: normal, attenuator: none, dispersive crystal (S═Ge, C═LiF), detector (S=FPC, C=FPC)

### (Forming Third Layer)

Further, the “covering resin 1” is added in the amount of 1.2 parts by mass, and the above is mixed and churned for 15 minutes at 22° C. Then, the above is mixed for 50 minutes at 120° C. With this, a third layer including the “covering resin 1” is formed on the second layer, and a “carrier particle 2” with a structure including three layers is made. The ratio of the weight of the nitrogen atom between the surface side and the carrier core material particle side in the resin covering layer of the obtained carrier particle 2 is surface side: core material particle side=1.00:1.86.

### (Making Carrier Particles 3 to 7)

Carrier particles 3 to 7 with a one or three layer structure are made similar to the method of making the carrier particle 1 or carrier particle 2 with the exception of changing the covering resin used as described in table 2.

Table 2 shows the covering resin used and the ratio of the weight of the nitrogen atom in carrier particles 1 to 7.

TABLE 2

| | | USED COVERING RESIN, ADDED AMOUNT, | | | |
|---|---|---|---|---|---|
| | CARRIER | PARTS BY MASS | | | RATIO OF WEIGHT OF |
| | PARTICLE | FIRST LAYER | SECOND LAYER | THIRD LAYER | NITROGEN ATOM *A |
| EXAMPLE 1 | CARRIER | COVERING RESIN 2 | NONE | NONE | 1.00:1.00 |
| | PARTICLE 1 | (3.6) | | | |
| EXAMPLE 2 | CARRIER | COVERING RESIN 2 | COVERING RESIN 1 (0.6) | COVERING RESIN 1 | 1.00:1.86 |
| | PARTICLE 2 | (1.2) | COVERING RESIN 2 (0.6) | (1.2) | |
| EXAMPLE 3 | CARRIER | COVERING RESIN 3 | COVERING RESIN 1 (0.6) | COVERING RESIN 1 | 1.00:1.33 |
| | PARTICLE 3 | (1.2) | COVERING RESIN 3 (0.6) | (1.2) | |
| EXAMPLE 4 | CARRIER | COVERING RESIN 2 | COVERING RESIN 4 (0.6) | COVERING RESIN 4 | 1.00:1.86 |
| | PARTICLE 4 | (1.2) | COVERING RESIN 2 (0.6) | (1.2) | |
| EXAMPLE 5 | CARRIER | COVERING RESIN 2 | COVERING RESIN 1 (0.6) | COVERING RESIN 1 | 1.00:1.86 |
| | PARTICLE 2 | (1.2) | COVERING RESIN 2 (0.6) | (1.2) | |
| EXAMPLE 6 | CARRIER | COVERING RESIN 2 | COVERING RESIN 1 (0.6) | COVERING RESIN 1 | 1.00:1.86 |
| | PARTICLE 2 | (1.2) | COVERING RESIN 2 (0.6) | (1.2) | |
| EXAMPLE 7 | CARRIER | COVERING RESIN 2 | COVERING RESIN 5 (0.6) | COVERING RESIN 5 | 1.00:1.86 |
| | PARTICLE 5 | (1.2) | COVERING RESIN 2 (0.6) | (1.2) | |
| COMPARATIVE | CARRIER | COVERING RESIN 6 | NONE | NONE | — |
| EXAMPLE 1 | PARTICLE 6 | (3.6) | | | |
| COMPARATIVE | CARRIER | COVERING RESIN 7 | NONE | NONE | — |
| EXAMPLE 2 | PARTICLE 7 | (3.6) | | | |

*A: SURFACE SIDE:CORE MATERIAL PARTICLE SIDE

The ratio of the weight of the nitrogen atom is the value obtained by measuring with the method as described above.

### <<Making Toner Particle>>

The toner particle is made as described below.

### <Making Toner Particle 1>

### (Making Core Resin Particle)

### (Making Resin Particle 1H)

7.08 parts by mass of dodecyl sodium sulfate which is an anionic surfactant is dissolved in 3010 parts by mass of ion exchange water in a reaction container with a churning device, a temperature sensor, a cooling tube and a nitrogen introduction device attached, and a surfactant solution is made. Then, the surfactant solution is churned at a speed of 230 rpm under a current of nitrogen gas, and the temperature in the reaction container is raised to 80° C.

Next, a polymerization initiator solution in which 9.2 parts by mass of potassium persulfate (KPS) as the polymerization initiator is dissolved in 200 parts by mass of ion exchange water is input in the surfactant solution, and the temperature in the reaction container is to be 75° C. Then, a compound liquid [a1] mixing the following is dropped over one hour.

styrene 69.4 parts by mass

n-Butyl acrylate 28.3 parts by mass

methacrylic acid 2.3 parts by mass

Then, the above is churned for two hours at 75° C. and polymerized. With this, a resin particle dispersion liquid [1H] in which resin particles 1H are dispersed is made.

### (Making Resin Particle 1HM)

The following are input in a flask with a churning device attached.

styrene 97.1 parts by mass

n-Butyl acrylate 39.7 parts by mass

methacrylic acid 3.22 parts by mass

n-octyl 3-mercaptopropionic acid ester 5.6 parts by mass

Further the following is added and the compound is heated to 90° C. to make a compound liquid [a2] by mixing the above compounds.

pentaerythritol tetrabehenate 98.0 parts by mass

1.6 parts by mass of dodecyl sodium sulfate is dissolved in 2700 parts by mass of ion exchange water in a reaction container with a churning device, a temperature sensor, a cooling tube and a nitrogen introduction device attached, and a surfactant solution is made. The surfactant solution is heated to 98° C., and the above resin particle dispersion liquid [1H] is added to the surfactant solution in the amount of 28 parts by mass in solid content conversion. Then, the compound liquid [a2] is input in the surfactant solution. Further, a mechanical dispersion apparatus “CLEARMIX” (product of M Technique Co., Ltd.) including a circulation path mixes and disperses for two hours to prepare a dispersion liquid (emulsified liquid).

Next, a polymerization initiator solution in which 5.1 parts by mass of potassium persulfate (KPS) is dissolved in 240 parts by mass of ion exchange water and 750 parts by mass of ion exchange water are added to the emulsified liquid. The reaction system is churned for two hours at 98° C., and polymerized. With this, a resin particle dispersion liquid [1HM] is made, and the resin particle 1HM with a composite structure of resin covering the surface of the resin particle 1H is dispersed in the resin particle dispersion liquid [1HM].

### (Making Resin Particle 1HML)

A polymerization initiator solution in which 7.4 parts by mass of potassium persulfate (KPS) is dissolved in 200 parts by mass of ion exchange water is added to the resin particle dispersion liquid [1HM] and the above is adjusted to a temperature of 80° C. Then, a compound liquid including the following is dropped over an hour.

styrene 277 parts by mass

n-Butyl acrylate 113 parts by mass

methacrylic acid 9.21 parts by mass

n-octyl 3-mercaptopropionic acid ester 10.4 parts by mass

After the dropping ends, the above is heated and churned for two hours maintaining 80° C., and polymerized. Then, the reaction system is cooled to 28° C. With this, a resin particle dispersion liquid [1HML] is prepared, and a resin particle 1HML including a composite structure with resin covering the surface of the resin particle 1HM is dispersed in the resin particle dispersion liquid [1HML]. The obtained resin particle is to be the “core resin particle”.

### (Making Resin Fine Particle for Forming Shell)

2.0 parts by mass of dodecyl sodium sulfate which is an anionic surfactant is dissolved in 3000 parts by mass of ion exchange water in a reaction container with a churning device, a temperature sensor, a cooling tube and a nitrogen introduction device attached, and a surfactant solution is made. Then, the surfactant solution is churned at a speed of 230 rpm under a current of nitrogen gas, and the temperature in the reaction container is raised to 80° C.

The following compounds are added and mixed to prepare a compound liquid [a4].

styrene 544 parts by mass

n-Butyl acrylate 160 parts by mass

methacrylic acid 96 parts by mass

n-octylmercaptan (NOM) 20 parts by mass

A polymerization initiator solution in which 10 parts by mass of potassium persulfate (KPS) is dissolved in 200 parts by mass of ion exchange water is added to the surfactant solution, and the above compound liquid [a4] is dropped over three hours. Then, the system is heated to 80° C., and heated and churned for one hour to polymerize the above. With this, the dispersion liquid of “resin fine particle for forming the shell” is made.

### (Making Carbon Black Dispersion Liquid)

A solution made by churning and dissolving 90 parts by mass of dodecyl sodium sulfate in 1600 parts by mass of ion exchange water is churned and 420 parts by mass of carbon black “Morgal L” is gradually added in the solution. Next, dispersion processing is performed using the dispersion apparatus “CLEARMIX” (product of M Technique Co., Ltd.) and “carbon black dispersion liquid” is made. The particle diameter of the carbon black in the “carbon black dispersion liquid” is measured using an electrophoretic light scattering photometer “ELS-800” (product of Otsuka Electronics Co., Ltd.). The weight average particle diameter is 110 nm.

### (Core Particle Forming Step)

The following is input in a reaction container provided with a churning device, a temperature sensor, a cooling tube and a nitrogen introduction device and the liquid temperature is adjusted to 30° C.

“core resin fine particle” dispersion liquid (solid content conversion) 450 parts by mass

ion exchange water 1100 parts by mass

“carbon black dispersion liquid” (solid content conversion) 100 parts by mass

Then, 5 mol/liter of sodium hydroxide aqueous solution is added to adjust the pH to 10.0.

The above reaction system is churned, and in this state, an aqueous solution in which 60 parts by mass of magnesium chloride hexahydrate is dissolved in 60 parts by mass of ion exchange water is added over ten minutes in the reaction system. After adding and leaving as is for three minutes, the process of raising the temperature starts. The temperature of this system is raised to 90° C. over sixty minutes. In a state maintaining 90° C., the resin particles are associated to grow the particles. The growth of the particle is confirmed by measuring the particle diameter of the associated particle using a “Multisizer 3” (product of Beckman Coulter, Inc.). Then, when the median diameter (D₅₀) in the volumetric basis is 5.5 μm, an aqueous solution in which 40.2 parts by mass of sodium chloride are dissolved in 1000 parts by mass of ion exchange water is added to the reaction system to stop the growth of the particle. With this, the “core particle” is formed.

### (Shell Forming)

Next, 550 parts by mass (solid content conversion) of the above “core particle” dispersion liquid is made to be 90° C., and 50 parts by mass (solid content conversion) of the “resin fine particle for shell forming” dispersion liquid is added. The churning is continued for one hour, and the “resin fine particle for shell forming” is fused to the surface of the “core particle”. Then, an aqueous solution in which 40.2 parts by mass of sodium chloride is dissolved in 1000 parts by mass of ion exchange water is added. This system is made to be 95° C. and heated and churned for twenty minutes to perform maturing processing. After the shell is formed, the above is cooled to 30° C.

The generated toner mother particle dispersion liquid is filtered and repeatedly cleaned with ion exchange water with a temperature at 35° C. Then, the above is dried with hot air at a temperature of 40° C., and the “toner mother particle” is made with a structure in which the shell covers the core surface.

(Mixing External Additive into Toner Mother Particle)

1.0% by mass of hydrophobic silica (number average primary particle diameter 12 nm, hydrophobic degree 68) and 1.5% by mass of hydrophobic titanium oxide (number average primary particle diameter 20 nm, hydrophobic degree 64) are added to the toner mother particle made above. After mixing using the Henschel mixer (product of Mitusi Miike Chemical Engineering Machinery Co., Ltd.), a sieve with openings at 45 μm is used to remove coarse particles. With this, a “toner particle 1” is made.

### <Making Toner Particle 2>

Toner particle 2 is made similar to the toner particle 1 with the exception of making the core resin particle without adding n-octyl 3-mercaptopropionic acid ester.

### <Making Toner Particle 3>

Toner particle 3 is made similar to the toner particle 1 with the exception of not adding hydrophobic silica to the toner mother particle.

### <<Making Two-Component Developer>>

### (Making Two-Component Developer 1)

100 parts by mass of the “carrier particle 1” and 6 parts by mass of the “toner particle 1” made above are input in the V-type mixer and mixed for five minutes under room temperature and normal humidity environment. With this, the “two-component developer 1” is made.

### (Making Two-Component Developers 2 to 9)

Two-component developers 2 to 9 are made similar to two-component developer 1 with the exception of making changes in the carrier particle and the toner particle used as shown in table 3.

Table 3 shows the carrier particle and the toner particle used in making the two-component developer.

TABLE 3

| | TWO-COMPONENT | | |
|---|---|---|---|
| EXAMPLE | DEVELOPER | CARRIER PARTICLE | TONER PARTICLE |
| EXAMPLE 1 | TWO-COMPONENT | CARRIER PARTICLE 1 | TONER PARTICLE 1 |
| | DEVELOPER 1 | | |
| EXAMPLE 2 | TWO-COMPONENT | CARRIER PARTICLE 2 | TONER PARTICLE 1 |
| | DEVELOPER 2 | | |
| EXAMPLE 3 | TWO-COMPONENT | CARRIER PARTICLE 3 | TONER PARTICLE 1 |
| | DEVELOPER 3 | | |
| EXAMPLE 4 | TWO-COMPONENT | CARRIER PARTICLE 4 | TONER PARTICLE 1 |
| | DEVELOPER 4 | | |
| EXAMPLE 5 | TWO-COMPONENT | CARRIER PARTICLE 2 | TONER PARTICLE 2 |
| | DEVELOPER 5 | | |
| EXAMPLE 6 | TWO-COMPONENT | CARRIER PARTICLE 2 | TONER PARTICLE 3 |
| | DEVELOPER 6 | | |
| EXAMPLE 7 | TWO-COMPONENT | CARRIER PARTICLE 5 | TONER PARTICLE 1 |
| | DEVELOPER 7 | | |
| COMPARATIVE | TWO-COMPONENT | CARRIER PARTICLE 6 | TONER PARTICLE 1 |
| EXAMPLE 1 | DEVELOPER 8 | | |
| COMPARATIVE | TWO-COMPONENT | CARRIER PARTICLE 7 | TONER PARTICLE 1 |
| EXAMPLE 2 | DEVELOPER 9 | | |

### EVALUATION

A commercially available copier “BIZHUB PRO 1200” (product of KONICA MINOLTA, INC.) is prepared as an evaluation apparatus of the two-component developer. Printing is performed by sequentially loading in the copier the two-component developer made above, and printing 500,000 sheets of characters and images with a printing rate of 3% on a transfer sheet of A4 size under an environment of room temperature and normal humidity (20° C., 55% RH) and an environment of high temperature and high humidity (30° C., 80% RH).

Evaluation is shown with Good, Fair, or Poor, each meaning the following.

Good: Good level

Fair: Acceptable for practical use

Poor: Not acceptable for practical use

### <Evaluation of Charge Amount>

The charge amount of the two-component developer is measured using the measurement apparatus of charge amount as shown in FIG. 2.

In FIG. 2, reference numbers 36 and 37 show parallel plate electrodes, reference number 38 shows variable capacity capacitor, reference numbers 39 and 40 show power sources, reference number 42 shows a personal computer, reference numbers 43 and 44 show resistance, reference number 45 shows a buffer, reference number 46 shows the two-component developer, and reference number 47 shows A/D conversion.

Measurement is performed by placing 50 mg of the two-component developer 46 while sliding between the parallel plate (aluminum) electrodes 36 and 37. The charge amount and weight of the toner supplied to the developing region is measured when the toner is developed under the conditions of a gap between electrodes being 0.5 mm, DC bias being 1.0 kV, AC bias being 4.0 kV, 2.0 kHz. The charge amount Q/m (μc/g) for each unit mass is obtained and this value is to be the charge amount.

The charge amount in room temperature and normal humidity (20° C., 55% RH) (NN) is obtained by measuring the two-component developer initially and after printing 500,000 sheets.

The charge amount in high temperature and high humidity (30° C., 80% RH) (HH) is obtained by measuring the two-component developer initially and after printing 500,000 sheets. The image printing rate is to be 50%.

The absolute value of the difference (NN−HH) between the charge amounts of the two-component developer according to the environment can be evaluated by ranking as described below.

Good: less than 20 μC/g

Fair: within range of 20 to 30 μC/g

Poor: exceeding 30 μC/g

### <Evaluation of Print Image>

### (Image Density)

The image density is evaluated by the following method. A solid image of 10 cm square is printed initially and after printing 500,000 sheets of characters and images with a printing rate of 5% under the environment of high temperature and high humidity (30° C., 80% RH). The image density is measured in 10 spots randomly with a reflection densitometer “RD-918” (product of Macbeth). The average density of the above is evaluated. Good and Fair are considered to meet standards.

Evaluation Standard

Good: image density passes 1.400

Fair: image density is within range of 1.250 to 1.400

Poor: image density is less than 1.250

### (Fogging)

The fogging is evaluated by the following method. A white sheet is printed after printing 500,000 sheets of characters and images with a printing rate of 3% and a printing rate of 35% alternately for each 20,000 sheets under the environment of room temperature and normal humidity (20° C., 50% RH). The white sheet density of the transfer material is evaluated. The white sheet density of the transfer material is measured in 20 spots in an A4 size, and the average value of the above is to be the white sheet density. The density is measured using the reflection densitometer “RD-918” (product of Macbeth). Good and Fair are considered to meet standards.

Evaluation Standard

Good: Fogging density is less than 0.003

Fair: Fogging density is within range of 0.003 to 0.010

Poor: Fogging density exceeds 0.010

Table 4 shows the evaluation result.

TABLE 4

| | DIFFERENCE IN CHARGE | | | | | |
|---|---|---|---|---|---|---|
| | AMOUNT DUE TO | | | | | |
| | ENVIRONMENT | | IMAGE DENSITY | | IMAGE FOGGING | |
| | VALUE (μC/g) | EVALUATION | VALUE | EVALUATION | VALUE | EVALUATION |
| EXAMPLE 1 | 7 | GOOD | 1.455 | GOOD | 0.001 | GOOD |
| EXAMPLE 2 | 5 | GOOD | 1.502 | GOOD | 0.001 | GOOD |
| EXAMPLE 3 | 11 | GOOD | 1.550 | GOOD | 0.002 | GOOD |
| EXAMPLE 4 | 11 | GOOD | 1.476 | GOOD | 0.004 | FAIR |
| EXAMPLE 5 | 13 | GOOD | 1.398 | FAIR | 0.005 | FAIR |
| EXAMPLE 6 | 22 | FAIR | 1.488 | GOOD | 0.006 | FAIR |
| EXAMPLE 7 | 23 | FAIR | 1.502 | GOOD | 0.007 | FAIR |
| COMPARATIVE | 39 | POOR | 1.202 | POOR | 0.023 | POOR |
| EXAMPLE 1 | | | | | | |
| COMPARATIVE | 33 | POOR | 1.123 | POOR | 0.028 | POOR |
| EXAMPLE 2 | | | | | | |

As shown in table 4, the “two-component developers 1 to 7” of the embodiment have stable image density even after printing a large number of sheets (500,000 sheets), has small change of charge amount even if the environment of printing changes (according to the present embodiment, change from room temperature and normal humidity to high temperature and high humidity), and no fogging even when the printing rate of the image changes (according to the present embodiment, change from printing rate 3% to 35%), and high quality printed matter is continuously obtained. With this, it is confirmed that the outstanding effects of the present invention can be achieved. Turning to the comparison examples “two-component developers 8 and 9”, there is a problem in the evaluation items described above, and it is confirmed that the outstanding effects of the present invention cannot be achieved.

Although various exemplary embodiments have been shown and described, the invention is not limited to the embodiments shown. Therefore, the scope of the invention is intended to be limited solely by the scope of the claims that follow and its equivalents.

The present application is based on Japanese Patent Application No. 2013-141401 filed on Jul. 5, 2013 to the Japanese Patent Office, which shall be a basis for correcting mistranslations.

What is claimed is:

1. A two-component developer for developing an electrostatic latent image comprising:
a toner particle including an external additive on a surface of a toner mother particle including at least a binding resin; and
a carrier particle including a resin covering layer on a surface of a carrier core material particle,
wherein the resin covering layer includes a covering resin obtained by polymerizing at least an isobutyl methacrylate monomer and includes a nitrogen atom as an atom composing the covering resin.

2. The two-component developer for developing an electrostatic latent image of claim 1, wherein when the resin covering layer is divided between a carrier core material particle side and a surface side, weight of a nitrogen atom included in the carrier core material particle side is 1.05 times or more of weight of a nitrogen atom included in the surface side.

3. The two-component developer for developing an electrostatic latent image of claim 1, wherein the binding resin includes at least polyester resin.

4. The two-component developer for developing an electrostatic latent image of claim 1, wherein weight average molecular weight of the covering resin is within a range of 300,000 to 900,000.

5. The two-component developer for developing an electrostatic latent image of claim 1, wherein the external additive includes a silica particle with an average particle diameter within a range of 70 to 130 nm.

6. The two-component developer for developing an electrostatic latent image of claim 1, wherein the resin covering layer includes covering resin obtained by copolymerizing at least the isobutyl methacrylate monomer and a methyl methacrylate monomer.

7. A manufacturing method of a two-component developer for developing an electrostatic latent image including a toner particle with an external additive attached on a surface of a toner mother particle including at least a binding resin; and a carrier particle with a resin covering layer formed on a surface of a carrier core material particle, the method comprising:
forming the resin covering layer including a nitrogen atom as an atom composing a covering resin in the covering resin obtained by polymerizing at least an isobutyl methacrylate monomer.

8. The manufacturing method of a two-component developer for developing an electrostatic latent image of claim 7 further comprising:
forming the resin covering layer so that weight of the nitrogen atom included in the resin covering layer increases stepwise or successively from a surface side to a carrier core material particle side of the resin covering layer.
